(19) United States
(12) Patent Application Publication
(10) Pub. No.: US 2026/0196383 A1
(43) Pub. Date: Jul. 9, 2026

(54) ELECTRIC WIRE AND METHOD FOR ROUTING ELECTRIC WIRE

(71) Applicant: Yazaki Corporation, Tokyo (JP)

(72) Inventors: Hiroki KONDO, Shizuoka (JP); Daisuke SUZUKI, Shizuoka (JP)

(73) Assignee: Yazaki Corporation, Tokyo (JP)

(21) Appl. No.: 19/559,541

(22) Filed: Mar. 6, 2026

Related U.S. Application Data
(63) Continuation of application No. PCT/JP2024/044203, filed on Dec. 13, 2024.

(30) Foreign Application Priority Data
Jan. 15, 2024 (JP) 2024-003753

(51) Int. Cl. H01B 7/36; H01B 7/04

(52) U.S. Cl. CPC H01B 7/361; H01B 7/04

(57) ABSTRACT

An electric wire includes a conductor, an orange-colored body provided on the conductor, and a transparent resin coated on the orange-colored body. The conductor has an outer diameter of 10 mm or more and 30 mm or less. The orange-colored body has a thickness of 1 mm or less, has elongation of at least 44.5%, and is prevented from cracking upon bending at R20 in a radial direction.

### CROSS-REFERENCE TO RELATED APPLICATIONS

This is a continuation of International Application No. PCT/JP2024/044203 filed on Dec. 13, 2024, and claims priority from Japanese Patent Application No. 2024-003753 filed on Jan. 15, 2024, the entire content of which is incorporated herein by reference.

### TECHNICAL FIELD

The present invention relates to an electric wire and a method for routing electric wire.

### BACKGROUND ART

With electrification of vehicles in recent years, electric wires have higher voltage and larger current to shorten charging time. Such electric wires having high voltage and large current need to appear in orange to ensure safety in vehicles. Therefore, in the related art, when a conductor is extrusion-coated with an insulator, an orange pigment is melted and mixed with a raw material such as polyvinyl chloride (PVC) or polyethylene (PE) to color the insulator of electric wires in orange.

However, when the orange pigment is mixed in the insulator of an electric wire, characteristics such as heat resistance of the insulator may deteriorate due to the orange pigment. In addition, when an ultraviolet (UV) curing resin that is cured by a transmission wavelength of UV is used for the insulator, it may be difficult for UV to transmit due to coloring and the resin may not be cured.

Therefore, it is conceivable to wind an orange tape around an electric wire whose insulator is not orange, or to insert an electric wire into an orange braid. However, in either case, when the tape or braid wears away due to vehicle vibration or the like, the electric wire may not appear in orange.

Therefore, an electric wire including a conductor, a color coating on the conductor, and a transparent insulating sheath on the color coating has been proposed (for example, see Patent Literature 1). By making the color coating orange in the electric wire, the electric wire can appear in orange through the transparent insulating sheath, and even when the electric wire is in an abrasive environment, the transparent insulating sheath can wear away and the appearance can be less likely to get lost.

### CITATION LIST

### Patent Literature

Patent Literature 1: JP2002-216548A

### SUMMARY OF INVENTION

### Technical Problem

Here, inventors of the present invention have studied electric wires having high voltage and large current. As a result of intensive studies by the present inventors, it is found that, in the electric wire described in Patent Literature 1, when an orange layer located inside a transparent resin (transparent insulating sheath) does not have an appropriate configuration, the orange layer cracks when the electric wire is bent. In particular, an electric wire having high voltage and large current tends to have a thick conductor, and a large strain is likely to be applied to the orange layer upon bending and the orange layer is likely to crack. Once cracking, the orange color may be overlooked, and the orange appearance may not be appropriate.

The present invention is made to solve such a problem in the related art, and an object of the present invention is to provide an electric wire and a method for routing electric wire that can prevent cracking of an orange-colored body located inside a transparent resin.

### Solution to Problem

According to an aspect of the present invention, there is provided an electric wire including: a conductor; an orange-colored body provided on the conductor; and a transparent resin coated on the orange-colored body, in which the conductor has a cross-sectional length in a prescribed direction in a cross section orthogonal to a longitudinal direction of 10 mm or more and 30 mm or less, and the orange-colored body has a thickness of 1 mm or less, has elongation of at least 44.5%, and is prevented from cracking upon bending at R20 in the prescribed direction.

### Advantageous Effects of Invention

According to the present invention, it is possible to provide an electric wire and a method for routing electric wire that can prevent cracking of an orange-colored body located inside a transparent resin.

### BRIEF DESCRIPTION OF DRAWINGS

FIG. 1 is a perspective view illustrating a first example of an electric wire according to an embodiment of the present invention.

FIG. 2 is a perspective view illustrating a second example of an electric wire according to an embodiment of the present invention.

### DESCRIPTION OF EMBODIMENTS

Hereinafter, the present invention will be described with reference to a preferred embodiment. The present invention is not limited to the embodiment to be described below, and can be appropriately changed without departing from the gist of the present invention. In the embodiment to be described below, there may be parts in which illustration and description of a part of a configuration are omitted, and it is needless to say that a publicly known or well-known technique is appropriately applied to details of an omitted technique within a range in which no contradiction with contents to be described below would occur.

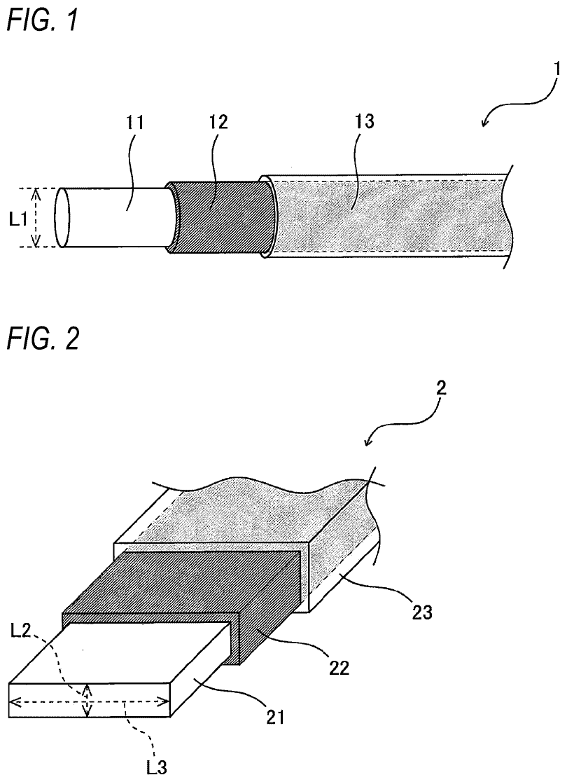

FIG. 1 is a perspective view illustrating a first example of an electric wire according to an embodiment of the present invention. As illustrated in FIG. 1, an electric wire 1 according to the first example includes a conductor 11, an orange-colored body 12, and a transparent resin 13.

The conductor 11 is made of, for example, copper, aluminum, or an alloy thereof, and is a round conductor having a circular cross section in the present embodiment. In the present embodiment, the conductor 11 is assumed to be a single wire that can cope with high voltage and large current, but is not particularly limited thereto, and may be constituted by two or more members (for example, a plurality of twisted wires).

The orange-colored body 12 is provided on the conductor 11, and is a member in which at least an outer peripheral side is orange. The orange-colored body 12 is implemented by, for example, a resin tape (vinyl tape or the like), a cloth tape, and a braid. The resin tape and the cloth tape each have an adhesive layer on one surface, and are longitudinally wrapped or spirally wrapped around the conductor 11 such that the adhesive layer is on a conductor 11 side. The braid is obtained by braiding a bundle of strands into a cylindrical shape, and is provided on the conductor 11 by the conductor 11 being inserted into the cylinder. The orange-colored body 12 of this type can withstand a temperature rise when a large current flows through the electric wire 1. The orange-colored body 12 can withstand a temperature of the transparent resin 13 when the transparent resin 13 is extrusion-coated on the orange-colored body 12 as described later.

Here, in the present embodiment, orange is assumed to be a color having a Munsell value in a range of 10R 6/16, 10R 7/14 and 10R 7/16. However, orange is not particularly limited thereto, and may be, for example, a color having a Munsell value in a range of 10R 8/22, 10R 8/24, 10R 8/26, 10R 7/18, 10R 7/20, 10R 7/22, 10R 6/18 and 10R 6/20.

The transparent resin 13 is an insulating resin coated on the orange-colored body 12. Specific examples of the transparent resin 13 include thermoplastic resins such as polycarbonate (PC), polymethyl methacrylate (PMMA), acrylic resins, and polystyrene. Examples of the transparent resin 13 further include UV curing resins such as urethane acrylate, epoxy acrylate, acrylic acrylate, and polyester acrylate. The transparent resin 13 preferably has a thickness of 2 mm or less.

FIG. 2 is a perspective view illustrating a second example of an electric wire according to the embodiment of the present invention. As illustrated in FIG. 2, an electric wire 2 according to the second example also includes a conductor 21, an orange-colored body 22, and a transparent resin 23.

In the second example, the conductor 21 is a busbar conductor having a rectangular cross section. Other configurations are the same as those of the conductor 11 of the first example. The conductor 21 may be constituted by two or more members such as two or more plates. In the second example, since the conductor 21 is a busbar conductor having a quadrangular cross section, the orange-colored body 22 is provided on the conductor 21 to have a quadrangular cross section. Further, since the orange-colored body 22 has a quadrangular cross-sectional shape, the transparent resin 23 is also coated on the orange-colored body 22 to have a quadrangular cross-sectional shape.

In the electric wires 1, 2 according to the present embodiment, since the transparent resins 13, 23 are coated on the orange-colored bodies 12, 22, orange can be recognized from outside. Accordingly, an operator or the like can recognize that the electric wires 1, 2 are for high voltage and large current. In addition, since the transparent resins 13, 23 are provided on the orange-colored bodies 12, 22, even when the electric wires 1, 2 are in an abrasive environment, the transparent resins 13, 23 can wear away and the orange appearance is less likely to get lost.

Further, in the present embodiment, the conductors 11, 21 each have a cross-sectional length of 10 mm or more and 30 mm or less in a prescribed direction in a cross section orthogonal to a longitudinal direction of the electric wires 1, 2. Specifically, since the electric wire 1 illustrated in FIG. 1 is a round electric wire, the prescribed direction is a radial direction. Therefore, it can be said that the conductor 11 has an outer diameter L1 of 10 mm or more and 30 mm or less. Since the electric wire 2 illustrated in FIG. 2 is a busbar electric wire, the prescribed direction is a thickness direction or a width direction. Therefore, it can be said that a length L2 of the conductor 21 in the thickness direction or a length L3 in the width direction is 10 mm or more and 30 mm or less.

The orange-colored bodies 12, 22 according to the present embodiment each have a thickness of 1 mm or less and each have at least elongation of 44.5%. Accordingly, the orange-colored bodies 12, 22 are prevented from cracking from a relationship between strain and the elongation applied to the orange-colored bodies 12, 22 when the electric wires 1, 2 are bent at curvature radius of R20 in the prescribed direction. That is, the orange-colored bodies 12, 22 are prevented from cracking when the electric wires 1, 2 are bent and routed at R20 or more in the prescribed direction.

Here, when the orange-colored bodies 12, 22 crack, the operator or the like may overlook the orange color. However, in the electric wires 1, 2 according to the present embodiment, the orange-colored bodies 12, 22 are prevented from cracking even upon bending at R20 in the prescribed direction. For this reason, probability of 25 overlooking the orange-colored bodies 12, 22 due to cracking is restricted.

In the present embodiment, the orange-colored bodies 12, 22 preferably each have elongation of 62% or more. This is because, theoretically, when the elongation is 62% or more, the orange-colored bodies 12, 22 can be prevented from cracking even when the electric wires 1, 2 are bent at R10 in the prescribed direction. That is, cracking can be prevented even when an electric wire is bent and routed in a relatively narrow place.

Next, examples and comparative examples of the present invention will be described. Tables 1 and 2 below show examples and comparative examples of the present invention. Tables 1 and 2 show results of a bending test carried out in a state in which an orange-colored body is coated with no transparent resin to confirm cracking of the orange-colored body.

TABLE 1

| | | | | Cross- | Overall | | | Presence |
|---|---|---|---|---|---|---|---|---|
| | | | | Sectional | Cross- | | | And |
| | Orange- | Thickness | | Length of | Sectional | | Strain | Absence |
| | Colored | of Colored | Elongation | Conductor | Length | Bending | Amount | of |
| | Body | Body (mm) | (%) | (mm) | (mm) | R | (%) | Cracking |
| Example 1 | Vinyl Tape | 0.09 | 180 | 10 | 10.18 | 30 | 14.51 | Good |
| Example 2 | (Longitudinally | 0.09 | 180 | 10 | 10.18 | 20 | 20.29 | Good |
| Example 3 | Wrapped) | 0.09 | 180 | 10 | 10.18 | 10 | 33.73 | Good |
| Example 4 | | 0.09 | 180 | 20 | 20.18 | 30 | 25.17 | Good |
| Example 5 | | 0.09 | 180 | 20 | 20.18 | 20 | 33.53 | Good |
| Example 6 | | 0.09 | 180 | 20 | 20.18 | 10 | 50.22 | Good |
| Example 7 | | 0.09 | 180 | 30 | 30.18 | 30 | 33.47 | Good |
| Example 8 | | 0.09 | 180 | 30 | 30.18 | 20 | 43.00 | Good |
| Example 9 | | 0.09 | 180 | 30 | 30.18 | 10 | 60.14 | Good |
| Example 10 | | 0.09 | 50 | 10 | 10.18 | 30 | 14.51 | Good |
| Example 11 | | 0.09 | 50 | 10 | 10.18 | 20 | 20.29 | Good |
| Example 12 | | 0.09 | 50 | 10 | 10.18 | 10 | 33.73 | Good |
| Example 13 | | 0.09 | 50 | 20 | 20.18 | 30 | 25.17 | Good |
| Example 14 | | 0.09 | 50 | 20 | 20.18 | 20 | 33.53 | Good |
| Comparative | | 0.09 | 50 | 20 | 20.18 | 10 | 50.22 | Poor |
| Example 1 | | | | | | | | |
| Example 15 | | 0.09 | 50 | 30 | 30.18 | 30 | 33.47 | Good |
| Example 16 | | 0.09 | 50 | 30 | 30.18 | 20 | 43.00 | Good |
| Comparative | | 0.09 | 50 | 30 | 30.18 | 10 | 60.14 | Poor |
| Example 2 | | | | | | | | |
| Example 17 | | 0.07 | 160 | 10 | 10.14 | 30 | 14.46 | Good |
| Example 18 | | 0.07 | 160 | 10 | 10.14 | 20 | 20.22 | Good |
| Example 19 | | 0.07 | 160 | 10 | 10.14 | 10 | 33.64 | Good |
| Example 20 | | 0.07 | 160 | 20 | 20.14 | 30 | 25.13 | Good |
| Example 21 | | 0.07 | 160 | 20 | 20.14 | 20 | 33.49 | Good |
| Example 22 | | 0.07 | 160 | 20 | 20.14 | 10 | 50.17 | Good |
| Example 23 | | 0.07 | 160 | 30 | 30.14 | 30 | 33.44 | Good |
| Example 24 | | 0.07 | 160 | 30 | 30.14 | 20 | 42.97 | Good |
| Example 25 | | 0.07 | 160 | 30 | 30.14 | 10 | 60.11 | Good |

TABLE 2

| | | | | Cross- | Overall | | | Presence |
|---|---|---|---|---|---|---|---|---|
| | | | | Sectional | Cross- | | | And |
| | Orange- | Thickness | | Length of | Sectional | | Strain | Absence |
| | Colored | of Colored | Elongation | Conductor | Length | Bending | Amount | of |
| | Body | Body (mm) | (%) | (mm) | (mm) | R | (%) | Cracking |
| Example 26 | PET Resin | 0.50 | 48 | 30 | 31 | 30 | 34.07 | Good |
| Example 27 | Cord | 0.50 | 48 | 10 | 11 | 30 | 15.49 | Good |
| Example 28 | | 0.50 | 48 | 10 | 11 | 20 | 21.57 | Good |
| Example 29 | | 0.50 | 48 | 10 | 11 | 10 | 35.48 | Good |
| Example 30 | | 0.50 | 48 | 20 | 21 | 30 | 25.93 | Good |
| Example 31 | | 0.50 | 48 | 20 | 21 | 20 | 34.43 | Good |
| Comparative | | 0.50 | 48 | 20 | 21 | 10 | 51.22 | Poor |
| Example 3 | | | | | | | | |
| Example 32 | | 0.50 | 48 | 30 | 31 | 30 | 34.07 | Good |
| Example 33 | | 0.50 | 48 | 30 | 31 | 20 | 43.66 | Good |
| Comparative | | 0.50 | 48 | 30 | 31 | 10 | 60.78 | Poor |
| Example 4 | | | | | | | | |
| Example 34 | | 1.00 | 44.5 | 30 | 32 | 30 | 34.78 | Good |
| Example 35 | | 1.00 | 44.5 | 10 | 12 | 30 | 16.67 | Good |
| Example 36 | | 1.00 | 44.5 | 10 | 12 | 20 | 23.08 | Good |
| Example 37 | | 1.00 | 44.5 | 10 | 12 | 10 | 37.50 | Good |
| Example 38 | | 1.00 | 44.5 | 20 | 22 | 30 | 26.83 | Good |
| Example 39 | | 1.00 | 44.5 | 20 | 22 | 20 | 35.48 | Good |
| Comparative | | 1.00 | 44.5 | 20 | 22 | 10 | 52.38 | Poor |
| Example 5 | | | | | | | | |
| Example 40 | | 1.00 | 44.5 | 30 | 32 | 30 | 34.78 | Good |
| Example 41 | | 1.00 | 44.5 | 30 | 32 | 20 | 44.44 | Good |
| Comparative | | 1.00 | 44.5 | 30 | 32 | 10 | 61.54 | Poor |
| Example 6 | | | | | | | | |

First, in Examples 1 to 25 and Comparative Examples 1, 2 shown in Table 1, the orange-colored body is a vinyl tape longitudinally wrapped around a conductor. The vinyl tape has a thickness of 0.09 mm in Examples 1 to 16 and Comparative Examples 1, 2, and 0.07 mm in Examples 17 to 25. The orange-colored body has elongation of 180% in Examples 1 to 9, 50% in Examples 10 to 16 and Comparative Examples 1, 2, and 160% in Examples 17 to 25. A cross-sectional length in a prescribed direction in a cross section orthogonal to a longitudinal direction of a target conductor on which the orange-colored body is provided is 10 mm in Examples 1 to 3, 10 to 12, and 17 to 19, and 20 mm in Examples 4 to 6, 13, 14, 20 to 22 and Comparative Example 1. Further, the cross-sectional length in the prescribed direction is 30 mm in Examples 7 to 9, 15, 16, 23 to 25 and Comparative Example 2.

The conductor and the orange-colored body as described above have an overall cross-sectional length in the prescribed direction of 10.18 mm in Examples 1 to 3 and 10 to 12, 20.18 mm in Examples 4 to 6, 13, 14 and Comparative Example 1, and 30.18 mm in Examples 7 to 9, 15, 16 and Comparative Example 2. The overall cross-sectional length in the prescribed direction is 10.14 mm in Examples 17 to 19, 20.14 mm in Examples 20 to 22, and 30.14 mm in Examples 23 to 25.

In Examples 26 to 41 and Comparative Examples 3 to 6 shown in Table 2, the orange-colored body is a resin cord (braid) of polyethylene terephthalate (PET), and the resin cord is provided outside the conductor by the conductor being inserted inside. The resin cord has a thickness of 0.50 mm in Examples 26 to 33 and Comparative Examples 3, 4, and 1.00 mm in Examples 34 to 41 and Comparative Examples 5, 6. The elongation of the orange-colored body is 48% in Examples 26 to 33 and Comparative Examples 3, 4, and is 44.5% in Examples 34 to 41 and Comparative Examples 5, 6. The cross-sectional length in the prescribed direction in the cross section orthogonal to the longitudinal direction of the target conductor on which the orange-colored body is provided is 10 mm in Examples 27 to 29, 35 to 37, and 20 mm in Examples 30, 31, 38, 39 and Comparative Examples 3, 5. The cross-sectional length in the prescribed direction is 30 mm in Examples 26, 32 to 34, 40, 41 and Comparative Examples 4, 6.

The conductor and the orange-colored body as described above have an overall cross-sectional length in the prescribed direction of 11 mm in Examples 27 to 29, 21 mm in Examples 30, 31 and Comparative Example 3, and 31 mm in Examples 26, 32, 33 and Comparative Example 4. The overall cross-sectional length in the prescribed direction is 12 mm in Examples 35 to 37, 22 mm in Examples 38, 39 and Comparative Example 5, and 32 mm in Examples 34, 40, 41 and Comparative Example 6.

A bending test was carried out on Examples 1 to 41 and Comparative Examples 1 to 6. In the bending test, presence and absence of cracking was checked by checking whether the conductor was exposed on a bending outer side when samples of Examples 1 to 41 and Comparative Examples 1 to 6, each of which has a prescribed length with one end fixed and the other end being a free end, were bent by 180 degrees in a prescribed direction along a mandrel. On the outer side of the 180-degree bending, a case where the exposure of the conductor was checked was evaluated as having a crack (“Poor” in Tables 1 and 2), and a case where no exposure of the conductor was checked was evaluated as having no crack (“Good” in Tables 1 and 2).

The mandrel used was R10 in Examples 3, 6, 9, 12, 19, 22, 25, 29, 37 and Comparative Examples 1 to 6, and R20 in Examples 2, 5, 8, 11, 14, 16, 18, 21, 24, 28, 31, 33, 36, 39, 41. The mandrel was R30 in Examples 1, 4, 7, 10, 13, 15, 17, 20, 23, 26, 27, 30, 32, 34, 35, 38, 40.

Calculated strain amounts in Examples 1 to 12 were 14.51%, 20.29%, 33.73%, 25.17%, 33.53%, 50.22%, 33.47%, 43.00%, 60.14%, 14.51%, 20.29%, and 33.73% in this order. The calculated strain amounts in Examples 13 to 23 were 25.17%, 33.53%, 33.47%, 43.00%, 14.46%, 20.22%, 33.64%, 25.13%, 33.49%, 50.17%, and 33.44% in this order.

The calculated strain amounts in Examples 24 to 35 were 42.97%, 60.11%, 34.07%, 15.49%, 21.57%, 35.48%, 25.93%, 34.43%, 34.07%, 43.66%, 34.78%, and 16.67% in this order. The calculated distortion amounts in Examples 36 to 41 were 23.08%, 37.50%, 26.83%, 35.48%, 34.78%, and 44.44% in this order. The calculated distortion amounts in Comparative Examples 1 to 6 were 50.22%, 60.14%, 51.22%, 60.78%, 52.38%, and 61.54% in this order.

In Examples 1 to 41 as described above, the elongation exceeded the calculated strain amounts, and no crack was checked in the results of the bending test. On the other hand, in Comparative Examples 1 to 6, the elongation did not exceed the calculated strain amounts, and cracking was also checked in the results of the bending test.

From the above test results, it is found that in a case where the cross-sectional length of the conductor in the prescribed direction is 10 mm or more and 30 mm or less and the thickness of the orange-colored body is 1 mm or less, cracking does not occur upon bending at R20 in the prescribed direction when the elongation of the orange-colored body is 44.5% or more. Further, from the test results, it is found that cracking does not occur upon bending at R10 in the prescribed direction at either elongation of 160% or elongation of 180% of the orange-colored body. In particular, from a viewpoint of calculation, when the elongation of the orange-colored body is 62% or more in the range in which the cross-sectional length of the conductor in the prescribed direction is 10 mm or more and 30 mm or less, it can be said that cracking does not occur upon bending at R10 in the prescribed direction.

In this manner, according to the electric wires 1, 2 in the present embodiment, the conductors 11, 21 each have a cross-sectional length of 10 mm or more and 30 mm or less in the prescribed direction in a cross section, and the orange-colored bodies 12, 22 each have a thickness of 1 mm or less and at least elongation of 44.5%. For this reason, when the electric wires 1, 2 are bent at R20 in a prescribed direction, the orange-colored bodies 12, 22 are prevented from cracking. Therefore, it is possible to provide the electric wires 1, 2 that can prevent cracking of the orange-colored bodies 12, 22 located inside the transparent resins 13, 23.

Further, when the orange-colored bodies 12, 22 each have elongation of 62% or more, cracking is prevented even upon bending at R10 in the prescribed direction. Therefore, it is possible to provide the electric wires 1, 2 that can prevent cracking of the orange-colored bodies 12, 22 even when the electric wires 1, 2 are locally bent.

Although the present invention is described above based on the embodiment, the present invention is not limited to the embodiment described above, modifications may be made without departing from the gist of the present invention, and publicly known or well-known techniques may be combined.

For example, in the present embodiment, the conductors 11, 21 are not limited to one member, and may be each constituted by two or more members. The orange-colored bodies 12, 22 are not limited to the Munsell colors exemplified above as long as the orange-colored bodies 12, 22 are colored in Munsell colors required by electric wires for high voltage and large current.

Here, characteristics of an electric wire and a method for routing electric wire according to the above embodiment of the present invention are briefly summarized and listed in following [1] to [3].

[1] An electric wire (1, 2) including:
a conductor (11, 21);
an orange-colored body (12, 22) provided on the conductor (11, 21); and
a transparent resin (13, 23) coated on the orange-colored body (12, 22), wherein
the conductor (11, 21) has a cross-sectional length (L1, L2, L3) in a prescribed direction in a cross section orthogonal to a longitudinal direction of 10 mm or more and 30 mm or less, and
the orange-colored body (12, 22) has a thickness of 1 mm or less, has elongation of at least 44.5%, and is prevented from cracking upon bending at R20 in the prescribed direction.

[2] The electric wire according to the above [1],
wherein the orange-colored body (12, 22) has elongation of 62% or more, and is prevented from cracking upon bending at R10 in the prescribed direction.

[3] A method for routing electric wire including:
bending and routing the electric wire according to the above [1] or [2] at R20 or more in the prescribed direction.

Although the present invention is described in detail and with reference to the specific embodiment, it is apparent to those skilled in the art that various changes and modifications can be made without departing from the spirit and scope of the present invention.

The present application is based on a Japanese patent application (JP2024-003753) filed on Jan. 15, 2024, and contents thereof are incorporated herein by reference.

### INDUSTRIAL APPLICABILITY

According to one aspect of the present invention, it is possible to provide an electric wire that can prevent cracking of an orange-colored body located inside a transparent resin. The invention having this effect is useful for an electric wire and a method for routing electric wire.

### REFERENCE SIGNS LIST

1, 2: electric wire
11, 21: conductor
12, 22: orange-colored body
13, 23: transparent resin
L1: outer diameter (cross-sectional length in prescribed direction)
L2: length in thickness direction (cross-sectional length in prescribed direction)
L3: length in width direction (cross-sectional length in prescribed direction)

1. An electric wire comprising:
a conductor;
an orange-colored body provided on the conductor; and
a transparent resin coated on the orange-colored body, wherein
the conductor has a cross-sectional length in a prescribed direction in a cross section orthogonal to a longitudinal direction of 10 mm or more and 30 mm or less, and
the orange-colored body has a thickness of 1 mm or less, has elongation of at least 44.5%, and is prevented from cracking upon bending at R20 in the prescribed direction.

2. The electric wire according to claim 1, wherein
the orange-colored body has elongation of 62% or more, and is prevented from cracking upon bending at R10 in the prescribed direction.

3. A method for routing electric wire comprising:
bending and routing the electric wire according to claim 1 at R20 or more in the prescribed direction.
